(19) United States
(12) Patent Application Publication
(10) Pub. No.: US 2008/0172671 A1
(43) Pub. Date: Jul. 17, 2008

(54) METHOD AND SYSTEM FOR EFFICIENT MANAGEMENT OF RESOURCE UTILIZATION DATA IN ON-DEMAND COMPUTING

(75) Inventors: Eric Bouillet, Englewood, NJ (US); Zhen Liu, Tarrytown, NY (US); Dimitrios Pendarakis, Westport, CT (US); Cary Perkins, Loveland, CO (US); Li Zhang, Yorktown Heights, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/622,163

(22) Filed: Jan. 11, 2007

(51) Int. Cl. G06F 9/46

(52) U.S. Cl. 718/104

(57) ABSTRACT

The present invention is based on the main ideas that different sub-intervals of a resource utilization time series are to be summarized with different granularity in the time axis, depending on the values of the series over that interval. Therefore, periods of high resource utilization are represented with higher time granularity, while periods of low resource utilization are represented with lower time granularity, the value stored can represent a function of the summarized values, such as the average or maximum value of the low resource utilization period. The captured resource utilization data is used to generate profiles, wherein the profiles summarize the historical utilization data. The profiles further capture pseudo-periodic behavior over different time scales.

### BACKGROUND OF THE INVENTION

1. Field of the Invention

This invention relates to the management of resource utilization data and particularly to the summarization of historical resource utilization data in a manner that preserves the essential characteristics of the data, wherein the data is utilized to assist in capacity planning activities and resource utilization considerations.

2. Description of Background

Before our invention, conventionally, on-demand computing service resources were allocated to customers in such a way that both contractual usage requirements and service level agreements were not being properly satisfied or these resources were over-provisioned, and hence underutilized. The efficient utilization of available resources illustrates the importance of dynamically adjusting resource allocations across differing customers and applications, as respective resource demands of parties and services vary over time. The sharing of common hardware resources across multiple customers is both desirable, and necessary in order to maximize the efficiency of a system. Therefore, the knowledge of past resource utilization statistics is essential to assist in ensuring the maximization of resource allocation, and additionally, the effective planning for the allocation of future resources.

Statistics can reveal long-term, and short-term trends for customer and application demand patterns, thus enabling the prediction of future values, and facilitating the planning of future resource allocations. By carrying out the collection of historical statistical data over a longer time period the clearer resource utilization patterns become, and correspondingly, the accuracy of predictions and allocation of resources becomes more efficient. A downside to the collection of significant amounts of statistical data is that the storage of the acquired data requires an ever-increasing amount of data storage space as the lengths of the historical time periods increase. Therefore, there currently exists a need for a methodology for determining an appropriate amount of storage space that can be dedicated to the storage of historical data statistics. Further needed are methodologies for the summarization of historical resource utilization data in a manner that preserves the essential characteristics of the historical resource utilization data from a resource capacity planning point-of-view.

### SUMMARY OF THE INVENTION

The shortcomings of the prior art are overcome and additional advantages are provided through the provision of a method for the summarization of computing resource utilization data of an on-demand computing system, wherein the method comprises the steps of monitoring resource utilization data, wherein the resource utilization data is monitored in periodic intervals over a predetermined amount of time, identifying time periods of high computer resource utilization and variability intervals in order to determine high computer resource utilization and variability data, and identifying time periods of low computer resource utilization and variability intervals in order to determine low computer resource utilization and variability data.

The method furthers comprises the steps of determining and preserving calculated high accuracy summarized values, determining and preserving calculated aggregated low accuracy summarized values. Additionally, the method comprises the steps of generating historical data profiles, wherein the historical data profiles are generated using the high accuracy and low accuracy summarized values, the historical data profiles containing information that represents long-term historical resource utilization data, and determining computer resource utilization values that are based upon the historical data profiles, wherein the determined computer resource utilization values represent a function of the summarized values.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and the drawings that are contained herein.

As a result of the summarized invention, technically we have achieved a solution that defines novel methodologies for the summarization of historical resource utilization data in a manner that preserves the essential historical statistics of the historical resource utilization data from a perspective that is vital to resource capacity planning and resource utilization.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a graph showing a time series period of historical resource utilization data.

FIG. 2 illustrates a graph showing a time series periods of high and low resource utilization intervals of historical resource utilization data.

FIG. 3 illustrates a graph showing a section of a time series period interval for the high resource utilization segment of historical resource utilization data.

FIG. 4 illustrates one example of a flow diagram that relates to aspects of the present invention.

The detailed description explains the preferred embodiments of the invention, together with advantages and features, by way of example with reference to the drawings.

### DETAILED DESCRIPTION OF THE INVENTION

On-demand computing is typically described as a business model application wherein computer resources are provided to customers in an on-demand/pay-per-use service. Therefore, customers, not having to make financial investments in computing resources, are only billed for agreed upon resource levels, or actual on-demand system usage.

Aspects of the present invention particularly illustrate that generally intervals of high resource utilization are much more important than those intervals of low utilization in the relating of resource utilization intervals to capacity allocation systems and methods. For example, in the case of resource utilization that is based upon peak or percentile value, only the highest values (those exceeding the peak or percentile values respectively) will be of use in determining the capacity or usage of system resources. Similarly, more sophisticated methods (e.g., those that are based on characterization of excess workloads) rely on the detailed knowledge of resource utilization statistics that are captured during intervals of high resource usage. Conversely, in terms of the capacity allocation results that are generated by these methods, periods of low resource utilization are less important.

Thus, the present invention is based on the main ideas that different sub-intervals of a resource utilization time series are to be summarized with different granularity in the time axis, depending on the values of the series over a time interval. Therefore, periods of high resource utilization are represented with higher time granularity, while periods of low resource utilization are represented with lower time granularity, thus, the stored value represents a function of the summarized values; such as the average or maximum value of a low resource utilization period. Captured resource utilization data is used to generate profiles, wherein the profiles are summaries of the historical utilization data. Profiles are further configured to capture pseudo-periodic behavior over different time scale periods (e.g., daily, weekly, monthly, yearly time periods).

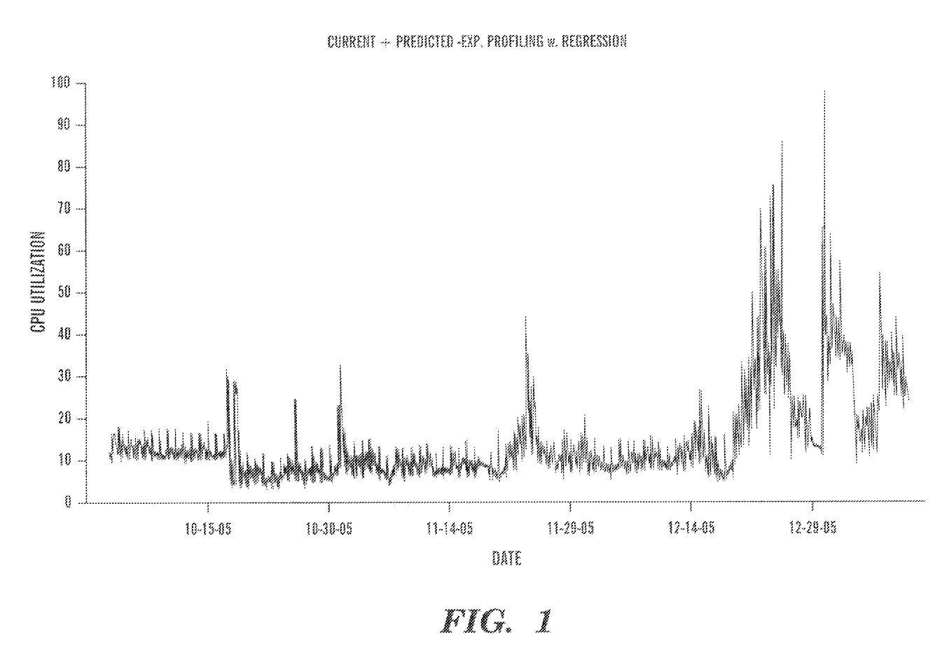

Turning now to the drawings in greater detail, it will be seen that FIG. 1 depicts a time series of observed (historical) resource utilization data, averaged in hourly intervals, over a period of approximately 3 months. A time series of such length may be required for capturing recurring and seasonal patterns, and thus, predicting future resource utilization. As can be observed in FIG. 1, the CPU utilization remains below 10% for a majority of the monitored time period; rarely does the CPU utilization exceed 20% usage. Nevertheless, as can be seen in FIG. 1, there are a number of significant spikes in the CPU resource utilization that exceed a 40% utilization factor, and in some instances are approaching 100% of the CPU utilization. From a CPU capacity sizing point-of-view, preserving detailed data pertaining to periods of high CPU resource utilization is desirable, since variations in the CPU utilization during the periods of low or very low utilization have essentially no impact in determining the capacity of the CPU.

Aspects of the present invention operate by identifying areas of a time series that are of high-utilization, and preserving the related utilization data with high accuracy. Further, parts of the time series that indicate low activity are subsequently replaced with aggregated statistics (e.g., the average value of the captured low activity values and the maximum and minimums of the low activity values). Given the range of potential sizing algorithms that may be employed within aspects of the present invention, the present method maintains an accurate representation of resource utilization data that is represented on the boundaries (i.e., located in proximity to the time domain axis) of high utilization areas of the graph as shown in FIG. 1.

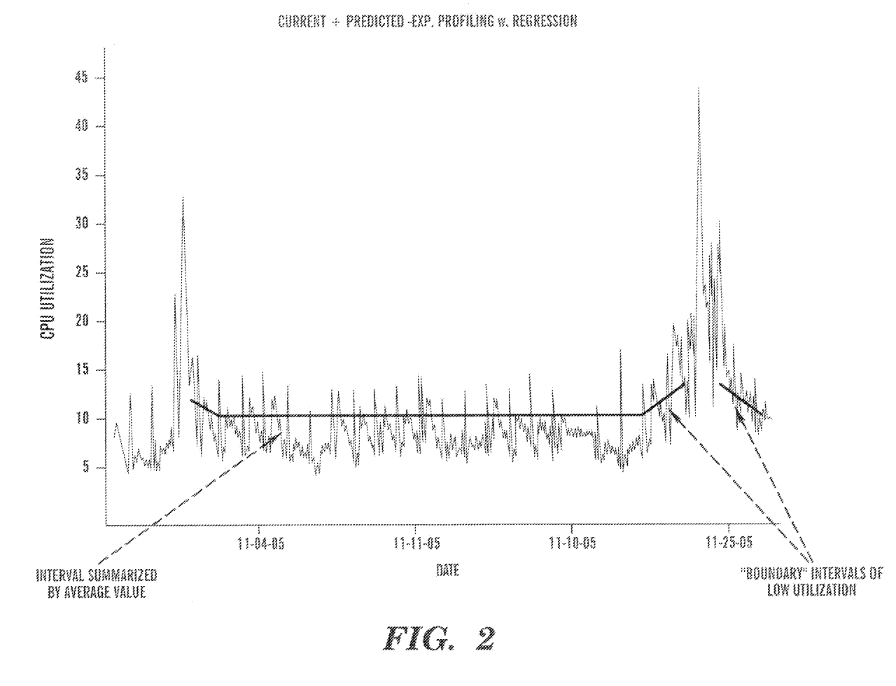

As further illustrated in FIG. 2, the middle interval of the time series that is consistently below 15% CPU utilization can be summarized using a single value (the average CPU utilization over this interval) or a small number of statistical parameters including average, minimum and maximum values. Therefore, instead of assigning one value for each hour in the time series, a single value (or few values) can be used to express the consistently low utilization values. Thus, within aspects of the present invention, the high CPU resource utilization intervals on the left and right ends of the time series axis are monitored and preserved in finer detail, while the intervals between the low and high CPU resource utilization intervals are preserved in progressively higher accuracy as the monitored CPU utilization factor rises.

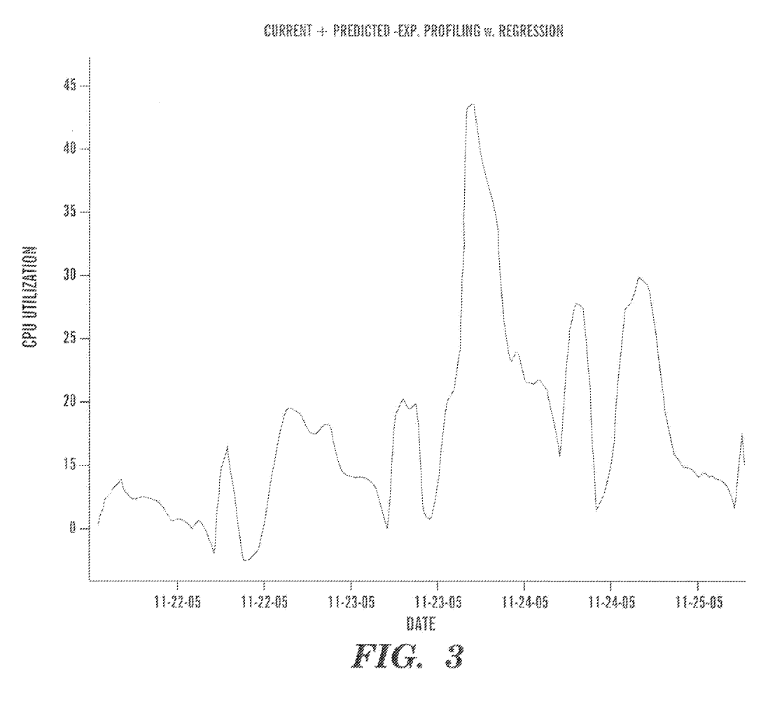

FIG. 3 shows a graph illustrating a high CPU resource utilization time interval that is featured within the time series axis as shown in FIG. 2. Data pertaining to this interval is represented with very fine granularity (e.g., averaged resource utilization measurements for every 15 minute time period). Further, as the resource utilization factors increase, target granularity increases. Granularity may decrease progressively for older utilization data; this aspect denotes that facets of the present invention can be applied recursively to the sub-intervals of a time series. Within aspects of the present invention, accumulated past data can be summarized in the form of a profile. Profiles possess as attributes data expressions of the recurring patterns and pseudo-periodicities of a time series. Thus, the combinations of accumulated profiles on different time-scales with summarized historical data are used to recreate past utilization data with increased accuracy.

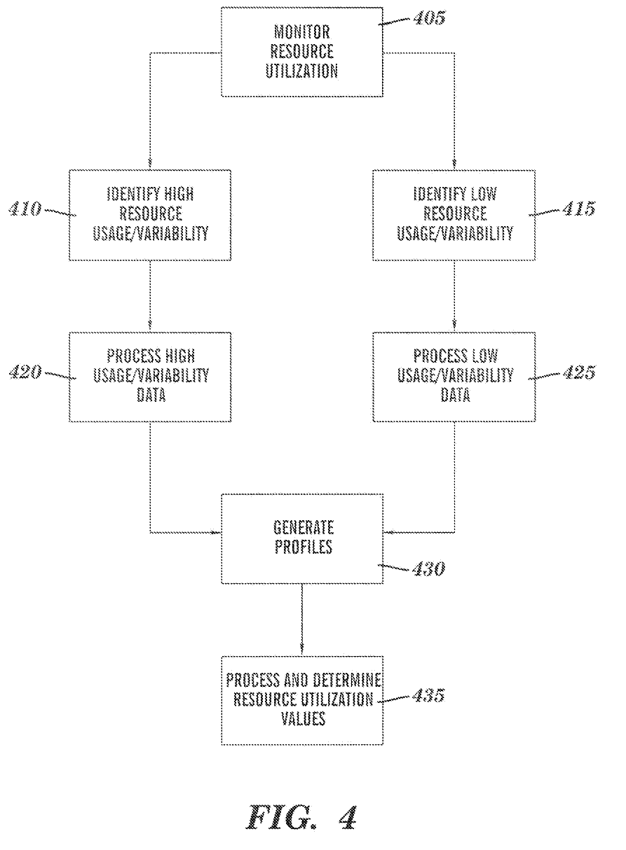

FIG. 4 shows a flow diagram illustrating methodological aspects of the present invention relating to the management of resource related system utilization data. At step 405, the methodology provides for the monitoring of resource utilization data, wherein the resource utilization data is monitored in periodic intervals over a predetermined amount of time. At step 410, the time periods of high computer resource utilization and variability intervals are identified in order to determine if there is high utilization of computer resources, and additionally if there is variability data that needs to be captured. Likewise, at step 415, the time periods of low computer resource utilization and variability intervals are identified in order to determine periods of low computer resource utilization and variability data.

At step 420 high accuracy algorithmic techniques are performed upon the high computer resource utilization and variability data in order to determine and preserve calculated high accuracy summarized values. These algorithmic techniques are determined based on the algorithms used to perform capacity planning. Examples of capacity planning algorithmic techniques include algorithms that calculate metrics of possible violations of customer Service Level Agreements (SLAs). These SLAs may be conditioned on resource utilization statistics exceeding certain threshold values, the time duration of exceeding these values, the magnitude of exceeding these values or combinations thereof. In addition to considering the metrics and profiles of how resource utilization statistics exceed certain thresholds, such algorithmic techniques may consider the amount of backlog resulting from conditions of overload, the duration of overload and the amount of time requird to clear the backlog. In these algorithms, backlog is generated during periods when the resource utilization reaches or exceeds certain threshold values (e.g., 80% or 100%). Therefore, summarization techniques preserving SLA metrics and/or backlog metrics are employed at this step.

At step 425 aggregated statistical techniques are performed upon the low computer resource utilization and variability data in order to determine and preserve calculated aggregated low accuracy summarized values. At step 430 historical utilization data profiles are generated, wherein the historical data profiles are generated using the high accuracy and low accuracy summarized values; the historical data profiles contain information that represents long-term historical resource utilization data. And lastly, at step 435, computer resource utilization values that are based upon the historical data profiles are determined, wherein the determined computer resource utilization values represent a function of the summarized values. Thereafter, the historical data profiles can be used to assist in server capacity planning, and the consolidation of server capacity operations.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed:

1. A method for the summarization of computing resource utilization data of an on-demand computing system, wherein the method comprises the steps of:
monitoring resource utilization data, wherein the resource utilization data is monitored in periodic intervals over a predetermined amount of time;
identifying time periods of high computer resource utilization and variability intervals in order to determine high computer resource utilization and variability data;
identifying time periods of low computer resource utilization and variability intervals in order to determine low computer resource utilization and variability data;
determining and preserving calculated high accuracy summarized values;
determining and preserving calculated aggregated low accuracy summarized values;
generating historical data profiles, wherein the historical data profiles are generated using the high accuracy and low accuracy summarized values, the historical data profiles containing information that represents long-term historical resource utilization data; and
determining computer resource utilization values that are based upon the historical data profiles, wherein the determined computer resource utilization values represent a function of the summarized values.

2. The method of claim 1, wherein the historical data profiles further comprise data that relates to the pseudo-periodic behavior patterns of the computing system over predetermined periodic time intervals.

3. The method of claim 1, further comprising the step of archiving the historical data profiles.

4. The method of claim 1, wherein the computer resource utilization values comprise an average of the low accuracy summarized values.

5. The method of claim 1, wherein the computer resource utilization values comprise a calculated maximum and minimum value for the low accuracy summarized values.

6. The method of claim 1, wherein the computer resource utilization values comprise a calculated maximum and minimum variance values for the low accuracy summarized value.

7. The method of claim 1, further comprising the step of maintaining an accurate representation of data that is monitored at time periods that are determined to bound high computer resource utilization and variability intervals.

8. The method of claim 1, further comprising the step of utilizing the historical data profiles for server capacity planning.

9. The method of claim 1, further comprising the step of utilizing the historical data profiles for the consolidation of server capacity.

10. A computer program product that includes a computer readable medium useable by a processor, the medium having stored thereon a sequence of instructions which, when executed by the processor, causes the processor to summarize the computing resource utilization data of an on-demand computing system, wherein the computer program product executes the steps of:
monitoring resource utilization data, wherein the resource utilization data is monitored in periodic intervals over a predetermined amount of time;
identifying time periods of high computer resource utilization and variability intervals in order to determine high computer resource utilization and variability data;
identifying time periods of low computer resource utilization and variability intervals in order to determine low computer resource utilization and variability data;
determining and preserving calculated high accuracy summarized values;
determining and preserving calculated aggregated low accuracy summarized values;
generating historical data profiles, wherein the historical data profiles are generated using the high accuracy and low accuracy summarized values, the historical data profiles containing information that represents long-term historical resource utilization data; and
determining computer resource utilization values that are based upon the historical data profiles, wherein the determined computer resource utilization values represent a function of the summarized values.

11. The computer program product of claim 10, wherein the historical data profiles further comprise data that relates to the pseudo-periodic behavior patterns of the computing system over predetermined periodic time intervals.

12. The computer program product of claim 10, further comprising the step of archiving the historical data profiles.

13. The computer program product of claim 10, wherein the computer resource utilization values comprise an average of the low accuracy summarized values.

14. The computer program product of claim 10, wherein the computer resource utilization values comprise a calculated maximum and minimum value for the low accuracy summarized values.

15. The computer program product of claim 10, wherein the computer resource utilization values comprise a calculated maximum and minimum variance values for the low accuracy summarized value.

16. The computer program product of claim 10, further comprising the step of maintaining an accurate representation of data that is monitored at time periods that are determined to bound high computer resource utilization and variability intervals.

17. The computer program product of claim 10, further comprising the step of utilizing the historical data profiles for server capacity planning.

18. The computer program product of claim 10, further comprising the step of utilizing the historical data profiles for the consolidation of server capacity.
